(19) United States
(12) Patent Application Publication
(10) Pub. No.: US 2006/0294140 A1
(43) Pub. Date: Dec. 28, 2006

(54) Computer based system and method for allocating and deploying personnel resources to transitory and fixed period work tasks

(75) Inventors: Alex Schemionek, Chicago, IL (US); David J. Tumminaro, Roselle, IL (US); Charles R. Steneck, Dundee, IL (US); Arianne R. Padre, Lombard, IL (US); Andrew J. Uram, Chicago, IL (US); Kurt Etterer, Chicago, IL (US); Barbara N. Tatic, Chicago, IL (US)

Correspondence Address: WINSTEAD SECHREST & MINICK P.C., PO BOX 50784, DALLAS, TX, 75201, US

(73) Assignee: American Airlines, Inc., Dallas, TX (US)

(21) Appl. No.: 11/168,845

(22) Filed: Jun. 28, 2005

(51) Int. Cl. G06F 7/00

(52) U.S. Cl. 707/104.1

(57) ABSTRACT

A computer based method for allocating and deploying personnel resources to transitory and fixed period work assignment tasks comprising the steps of: (a) providing a database containing work tasks related data; (b) providing a database containing personnel staffing data; (c) providing software which accesses the database of (a); (d) providing software which accesses the database of (b); (e) generating at least one personnel staffing data record via the software of (d) and storing the record within the database of (b); (f) generating at least one work task related data record via the software of (c) and storing said record within the database of (a); (g) interrogating and combining data records stored within the database(s) of (a) and (b) and storing the combined records into a database via software; (h) determining a user has communicated an input requirement via the software of (g) which requires interrogation of information contained in the database of (g); (i) interrogating the database of (g) in response to the user input requirement of (h); and (j) formatting interrogated information of (i) responsive to the user input requirement of (h) and communicating said formatted information to the user.

### CROSS REFERENCE

This application is not related to any pending application.

### STATEMENT OF FEDERALLY SPONSORED RESEARCH/DEVELOPMENT

This application is not federally sponsored research/development.

### REFERENCES TO SEQUENCE LISTING

This application is not referenced to any microfiche appendix.

### FIELD OF INVENTION

The present invention relates in general to data processing systems. In particular, the present invention relates to a computer based system and method for allocating and deploying personnel resources to transitory and fixed period work tasks.

### BACKGROUND OF INVENTION

A deficiency exists within contemporary or computer based methods for allocating and deploying personnel resources against transitory fixed period and variable length work period assignments, particularly with respect to airport manning systems. At the present time products are available that allow airport management to determine employees who should be on airport property, employees who are actually on the airport property, and what the anticipated shift workload is for each of these employees. What does not exist, however, is an effective computerized method to assign specific tasks (meeting flight arrivals, dispatching departures) to specific employees. To date, this process has been handled manually (pen and paper).

Airline customer service agents are assigned arrivals to meet and departures to dispatch throughout each workday. “Available” agents are those agents scheduled to work over a given period of time. Typically, this information is printed daily from an existing “manning” system that compares scheduled agents against known exceptions such as sick calls, vacation, etc.

Flight scheduling information is routinely obtained manually from a host system that defines the workload for a variety of agent manning coordinators. In the case of commercial airlines, this information is gleaned from a number of proprietary databases and software systems such as, but not limited to, the SABRE®/Passenger Service System (PSS) and Flight Operating System (FOS) System of American Airlines®.

The manning coordinators work from a printed copy of the available manning, that is, personnel available to meet an arrival or departure. A final schedule of information for each agent is then manually typed into a host system, such as the American Airlines Passenger Service System, in the form of an information record. In American's case, this is presented as a “STAR” record in SABRE so that each agent may view his or her work assignments/schedule on demand.

As flight schedules change throughout the day due to delays, cancellations, weather, and mechanical causes, the manning coordinators will reconcile schedule modifications with a particular agent's schedule by repeating the process noted above, that is downloading the most current information and rescheduling agents via the pencil and paper dozens, perhaps hundreds, of times daily.

### SUMMARY OF INVENTION

Given the deficiencies of the contemporary art it is an object of the present invention to provide, disclose, and claim a computer based method for allocating and deploying personnel resources to transitory, fixed period, and variable length work assignment tasks.

It is a further object of the instant invention to provide a computer based method for allocating and deploying personnel resources to transitory fixed period and variable duration work assignment tasks comprising the steps of: (a) providing a first database containing work tasks related data; (b) providing a second database containing personnel staffing data; (c) providing first software which accesses the database of (a); (d) providing second software which accesses the database of (b); (e) generating at least one personnel staffing data record via the second software and storing the record within the database of (b); (f) generating at least one work task related data record via the first software and storing said record within the database of (a); (g) interrogating and combining data records stored within the database of (a) and (b) and storing the combined records into another database via software of the present invention; (h) determining that a user has communicated an input requirement via the software of (g) which requires interrogation of information contained in the database of (g); (i) interrogating the database of (g) in response to the user input requirement of (h); and (j) formatting interrogated information of (i) responsive to the user input requirement of (h) and communicating said formatted information to the user.

### BRIEF DESCRIPTION OF DRAWINGS

For a more complete understanding of the present invention, and the advantages thereof, reference is now made to the following descriptions taken in conjunction with the accompanying drawings, in which:

FIG. 1 illustrates a system diagram illustrating major hardware, software and communication components of the present invention;

FIG. 2 is a logic flow non-limiting sequence of instruction step sequences to effectuate the practice of the instant invention's method; and

FIGS. 3 and 4 illustrate representative Graphic User Interface-Screen Images which may be utilized in the practice of the instant invention.

### DETAILED DESCRIPTION OF THE INVENTION

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the instant invention.

The claims and specification describe the invention presented and the terms that are employed in the claims draw their meaning from the use of such terms in the specification. The same terms employed in the prior art may be broader in meaning than specifically employed herein. Whenever there is a question between the broader definition of such terms used in the prior art and the more specific use of the terms herein, the more specific meaning is meant.

Referring now to the drawings wherein depicted elements are not necessarily shown to scale and wherein like or similar elements are designated by the same reference numeral through the several views.

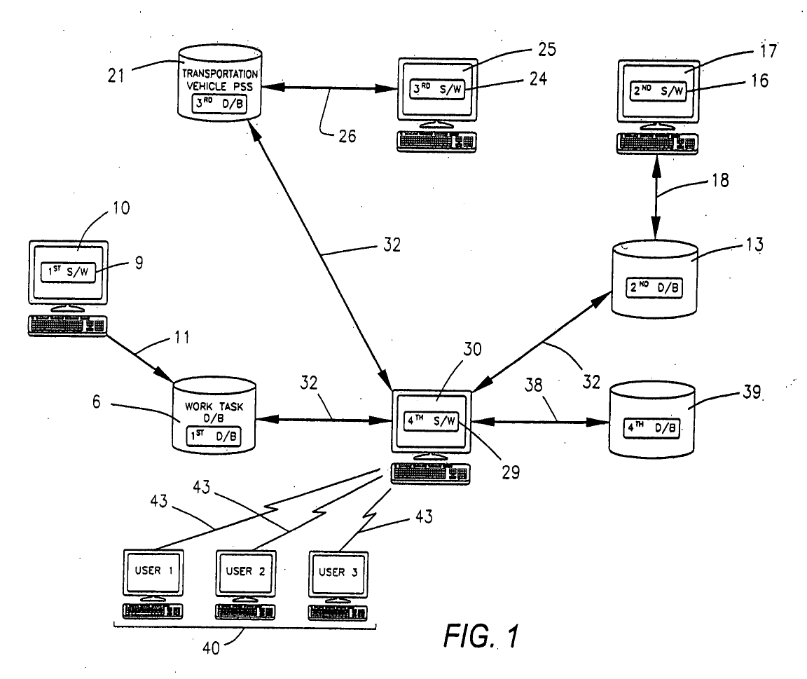

FIG. 1 illustrates a system diagram illustrating major hardware, software and communication components of the present invention. In FIG. 1 it may be observed where first software 9 operating under the dispatching control of host processor 10 is in communication 11 with database 6. The first software 9 is typically a proprietary software system which has the processing capability to generate at least one work related task and store elements relating to that work related task within database 6. For purposes of full and enabling disclosure, the present invention will be discussed within the context of airline related work tasks and personnel deployment requirements though it will be certainly appreciated by those skilled in the art that the invention may be readily applied and indeed practiced within a multiplicity of industries with personnel or task assignment requirements.

Continuing our discussion of FIG. 1. In FIG. 1, the first software 9 is any software capable of defining elements (“information sets”) necessary to identify and determine one or more work task requirements, such as but not limited to, the flight operation system work task requirements of aircraft arrival times, aircraft departure times, flight weather and mechanical delay information, etc. These information sets may be defined via a data dictionary mechanism or other indexing system where relevant information may be identified via an indexing structure and stored as hierarchical, relational, or other database indexing scheme.

FIG. 1 further discloses a second software 16 which is typically though not limitedly to a proprietary or readily available personnel staffing software. Note however, that software 9 in FIG. 1 illustrated as executing under the dispatching control of central processing unit 10 may also be operational within the central processing unit 17 or resident within one or more of the other central processing units illustrated in FIG. 1 (25, 30). The personnel staffing software 16 (second software) defines data elements such as, but not limited to, those individuals scheduled to work a given shift or period who are available for manning or deployment against work task assignments previously identified and stored within database 6. The personnel staffing database is routinely updated and personnel available for staffing are stored as one or more data elements within the second database 13 by second software 16.

A third software 24 operating under the dispatching control of central processing unit 25 is in communication 26 with a third database 21. The third software 24 and third database 21 illustrated in FIG. 1 may or may not be present in alternative invention embodiments. However, within the context of the airline practice presented herein such software typically relates to a Proprietary Passenger Service System (a.k.a. “PSS”) and communicates 26 with a third database 21 containing transportation vehicle data elements such as but not limited to vehicle identification information such as an aircraft number.

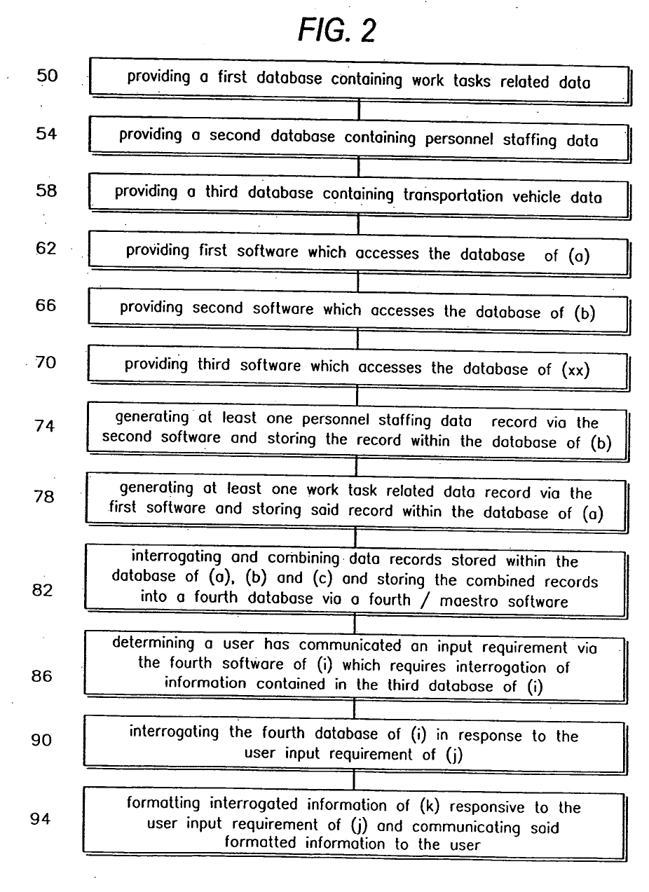

Fourth software 29 operates under the dispatching control of central processing unit 30 with software 29 communicates 32 with personnel staffing database 13, transportation vehicle database 21 (optional), and work task database 6. Information is gleaned from each of the afore-noted databases by fourth software 29 and stored as a composite record within a fourth database 39. The composition and construct of database elements stored upon third database 39 via communication means 38 will be discussed in detail in association with the practice and claims of the present invention in association with FIG. 2.

One or more users 40 communicate via a computer compatible network 43 to the central processing unit 30 executing fourth software 29. In one embodiment of the instant invention it is contemplated that the communication of users 40 with CPU 30 and software 29 occurs via web enabled software which facilitates interaction between the fourth software 29 of the instant invention and one or more users 40. Succinctly stated, the fourth software of the instant invention 29 recognizes input requested by users 40, inquires of and retrieves from database 39, information sufficient to address the user input inquiries. Once so retrieved, the fourth software 29 formats and presents such requested information back to one or more users 40. Users 40 as represented in FIG. 1 represent a highly integrated user community consisting of but not limited to persons inquiring of work task deployment for a particular period, as well as staffing coordinators and administrators who enroll or otherwise control execution parameters of fourth software 29 and administer and assign such individuals work task deployment for a given period.

Prior to discussing FIG. 2, it is important to note the present invention provides for a number of administrator and staffing coordinator functions by which the deployment of personnel resources to work tasks may be facilitated via graphic user interface (GUI) functionality and processing. Such processing with respect to the instant invention allows for “drag and drop” and other automated manipulation techniques readily recognized by those skilled in the art. It is reserved however that such automated manipulation techniques while readily appreciated by those skilled in the art remain unknown when used in combination with the unique and novel practice of the instant invention. Such administrator and manning coordinator processing techniques will be provided and discussed in detail following the discussion of FIG. 2 which illustrates and describes a logic flow non-limiting sequence of instruction step sequences necessary to effectuate the practice of the instant invention's method. Turning now to FIG. 2.

In FIG. 2, it is seen where a first database containing work task related data is provided 50. Work task related information as used herein is used synonymously and interchangeably with information relating to actual or estimated time required for a given task completion. Within the context of the present invention's description which relates to commercial airline work tasks, such task would include, but not be limited to, schedule aircraft arrival times, schedule departure times, actual arrival time, actual departure time, taxi in time, taxi out time, arrival gate, departure gate, tail number, actual equipment type, passenger counts, aircraft capacity, schedule destination, previous length flight information, length next flight information, ground objectives, etc.

The invention next calls for the providing of a second database containing personnel staffing data 54. Such data would include but not be limited to employee number, employee first name, employee last name, employee status, shift start time, shift off time, department, position, exception type, job, job start time, job end time, qualification, length exception employee last name, length exception employee first name, length exception employee number, length exception employee position, length exception employee department, exception time start and exception time off.

A third database may optionally be provided in 58 which contains supplemental information such as passenger counts, aircraft identification information and any other exceptional data which may be required to effectuate an accurate deployment of resources to the work task assigned.

Within the context of a commercial airline computer based method for allocating deploying personal resources, it is anticipated that the first database would contain flight operation information such as that typically created and maintained in proprietary flight operating systems of commercial airlines 62. One such example, would be the processing capability and data elements presented by the American Airlines® Flight Operating System (FOS) or any future contemplated, similarly intended and practiced software. The second database would typically contain personnel staffing data produced by proprietary and/or “of the shelf” personnel systems 66. One such example of proprietary software would be the American Airlines “StaffAdmin” software and any and all commercially available off the shelf of proprietary counterparts. The third database containing transportation vehicle data, when utilized, would typically contain passenger related information or alternatively cargo related information with one example of such a software system would be the American Airline PSS information typically including passenger's name, total count aboard aircraft and any other flight specific information 70.

Continuing our discussion of FIG. 2, the practice of the present invention requires the generation of at least one personnel staffing record 74 via the second software and storing the record within the second database. As used herein, the term “record” and “data element(s)” are intended to be used interchangeably and synonymously. At least one work task related data record is generated via the first software 78 (with that record stored within the first database for purposes of subsequent accessibility). Within the context of the commercial airline example, a third database record comprised of flight specific or cargo specific information may be likewise generated and stored into a third database containing transportation vehicle data.

It will be appreciated by those skilled in the art that this invention is disclosed herein as referencing four distinguishable databases via four software means. It is further appreciated that a variable number of databases may be utilized to effectuate the practice of the instant invention as may be one or more combined software means. Consequently, the information herein presented is not to be construed as limiting to four distinguishable software means and/or database references, but rather any functional combination of such databases, software and systems.

Fourth software interrogates and combines data records stored within the first, second (and optionally third databases) and stores the combined records in the fourth database 82. The fourth software is used herein may be defined as web processing software which facilitates interaction between one or more users via graphic user interfaces or indeed may be a proprietary software system such as but not limited to the American Airlines SABRE System. The fourth software next determines if a user has communicated an input requirement which requires interrogation of information now contained in the fourth database 86. Such requested information may relate to one or more of a variety of processing capabilities such as, but not limited to, system administration function, staff manning functions and/or work task assignment for an individual person. The invention next interrogates the fourth database 90 in response to the user requirement, determines the information to be required to satisfy the user inquiry, formats the interrogated information into a screen presentation and/or text viewable presentation and communicates the formatted information to the user via a communication means 94. It is to be further noted throughout this disclosure the communication means used herein may be any computer compatible communication means comprised of one or more networks to facilitate the transmission of data between user's software and databases.

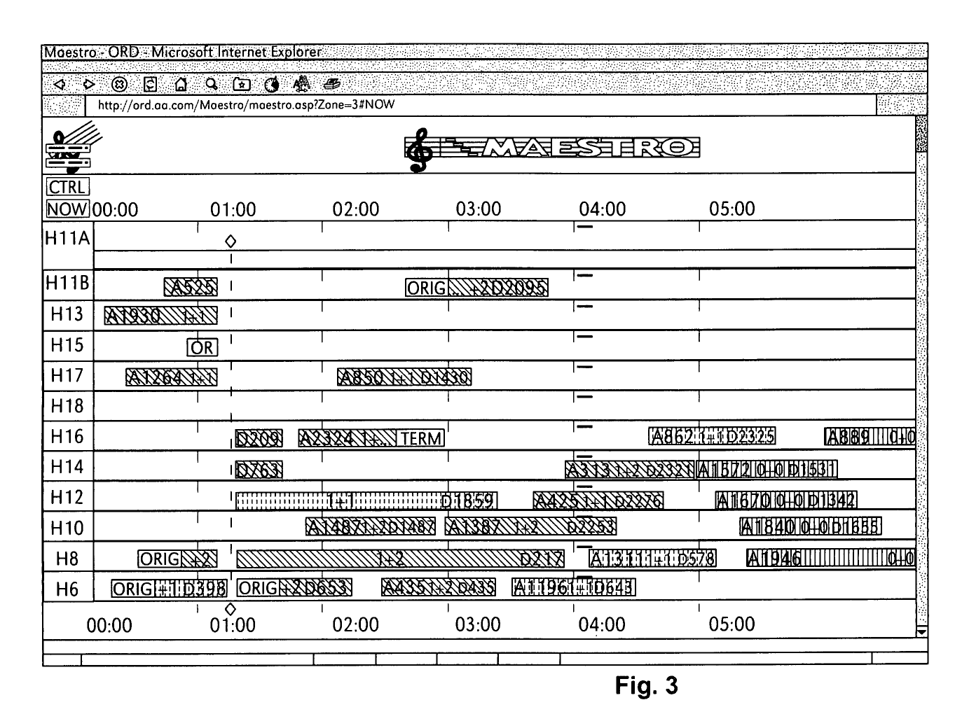

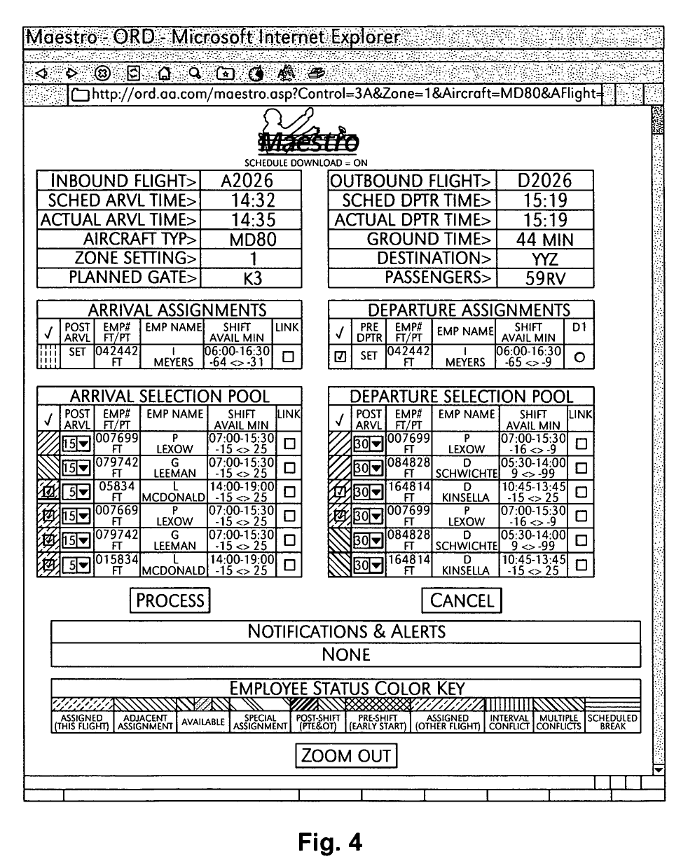

The following discussion relates to the invention in association with the GUI's of FIGS. 3-4 and provides a discussion of an example of the instant invention's practice as executed by airline users, staffing coordinators and administrators. Scrolling techniques, color utilization and intersection techniques may be readily modified as will be appreciated by those skilled in the art of software programming and systems design. Consequently, the following discussion is provided for purposes of example and full and enabling disclosure, and is not to be construed as limiting the invention's practice and claims.

In FIG. 3, the Gate vs. Time display illustrates the gates used at a particular airport (down the left axis) against a timeframe (across the top axis) to allow user's to scroll right and left through the day or up and down through the list of gates. The time display may be broken into one-hour segments for easy viewing. As the user scrolls to the right, flight “pucks” come in to view, based upon the arrival time of the aircraft (if it's a thru or turn flight), or upon the departure time (if it is an originating flight). A dotted red vertical line may be used to indicate the current time. Each “puck” in the display represents an operation (either an arrival, departure, or both). Originating flights are designated with an “ORIG” tag. If the operation is a thru or turn flight, the inbound flight number is display. In the middle of each puck current manning assignments (expressed in physical bodies assigned) are displayed. Additionally, the color of the flight pucks can be programmed to change based upon the amount of manning assigned. The determination of the color is based upon easily changed parameters that are based upon the booking level of the flight. As an example, red could indicate no manning yet assigned; yellow indicate some manning assigned, but under-manned; green indicate appropriate manning assigned; and blue indicate over-manning. In order to assign a task, a manning coordinator will simply click on a flight puck to which they will assign one or more agents. A brief description of what may be displayed on the screen can be found below.

If applicable, an arriving aircraft information is displayed in the “Inbound Flight” section beginning with the flight number. If the departure is originating, no inbound aircraft information is displayed. Otherwise, the scheduled arrival time, actual arrival time, type of aircraft, and currently planned arrival gate of the inbound aircraft is displayed. Users may slice up the airport into Zones (physical division of gates) or display all. If applicable, the departing aircraft information is displayed in the “Outbound Flight” section beginning with the flight number. If the arrival aircraft is terminating, outbound aircraft information is not displayed. Otherwise, the scheduled departure time, actual departure time, destination, and the number of revenue customers currently booked (non-revenue customers are omitted) of the outbound aircraft is displayed. If an arrival and departure exist, the actual ground time of the aircraft is also displayed. If the aircraft terminates or originates, no ground time is displayed. The actual name(s) of the agent(s) currently assigned to meet the arrival aircraft is also displayed. If an agent has yet to be assigned, “No-Arrival Assignments” is displayed. A default setting to make an agent available to meet an arrival is that they must be at the arrival gate a minimum of 15 minutes prior to the actual arrival time of the aircraft. This is done so that there is time to print connection lists and position the jetbridge for the type of aircraft that is arriving.

The arrival selection pool displays the list of agents that could possibly be assigned to meet the arrival aircraft as seen in FIG. 4. In order to be considered an agent must have been available at least 15 minutes prior to the actual arrival. It is then a matter of how much time the agent is available post-arrival for customer processing, if necessary. Agents may be color-coded based on their type of availability. An potential example of a color hierarchy follows:

Yellow: already assigned to meet this arrival

Dark Green: available at least 15 minutes pre-arrival and is available to meet and greet customers for at least 15 minutes post-arrival.

Pale Green: available at least 15 minutes pre-arrival and is available to meet and greet customers for less than 15 minutes post-arrival

Dark Purple: in order to assign an agent that is coded this color, the agent's shift will need to be extended to meet this arrival. By definition the agent's extension will be at time (not overtime).

Light Purple: in order to assign an agent that is coded this color, the agent's shift will need t be extended into overtime to meet this arrival.

Red: agent is already assigned to either meet and arrival or dispatch a departure at the time this aircraft is planned to arrive. In order to assign an agent coded red, the coordinator would need to de-assign them from the other task first.

There are six columns underneath the Arrival Selection Pool section. These are defined as follows:

✓

A coordinator would check this box if they wish to assign a particular agent to meet the arrival.

POST-ARVL

Number of minutes after the arrival is in that the coordinator wishes to allot for the agent to meet and greet inbound customers. Can be anywhere from 5 to 120 minutes in 5 minute increments.

EMP#/STAT

Employee number of the agent's name found in the next column. “STAT” indicates whether the agent is scheduled full or part time today.

EMP NAME

Name of the employee.

SHIFT/AVAIL MIN

Shift of the agent for today expressed with Start Time and Off Time. “AVAIL MIN” is an indicator that tells the coordinator how many minutes (the left number) since the agent's last assignment and how many minutes (the right number) until the agent's next assignment.

LINK

When the coordinator is planning to assign the agent to the corresponding departure, the box may be “checked” indicating to “link” the agent meeting the arrival to the agent dispatching the departure. If this filed is left unchecked, the agent is free to be assigned to another departure in the interim (useful for long aircraft ground times).

Actual name(s) of the agent(s) currently assigned to dispatch the outbound aircraft is displayed. If no agent is assigned, “No Departure Assignments” is displayed.

The default setting to assign an agent as the primary agent to dispatch a departure is that they must be at the departure gate at least 60 minutes prior to the latest departure time. The default setting to assign an agent as the assist agent to dispatch a departure is that they must be at the departure gate at least 45 minutes prior to the latest departure time. The departure selection pool displays the list of agents that could possibly be assigned to dispatch the outbound aircraft. Agents are color-coded based on their type of availability. An example color hierarchy follows:

Yellow: already assigned to this departure.

Dark Green: available at least 60 minutes pre-departure and can be assigned as the primary agent.

Light Green: available 45 minutes pre-departure and can be assigned as an assist agent.

Pale Green: partially available. Can be added to a departure as a second assist. Duties related to this particular position are generally found during the last 30 minutes prior to departure.

Black: agent is on a scheduled break. In order to assign this agent he break would have to be interrupted and/or moved to another time.

Dark Blue: Agent is on a special assignment such as on-shift training, assigned to the service center, has been shifted to work at the ticket counter, is acting in a higher capacity or has been assigned to some sort of administrative work.

Dark Purple: In order to assign an agent that is coded this color, the agent's shift will need to be extended past the scheduled off time in order to be assigned to this departure. By definition the agent's extension will be at “time” (not overtime).

Light Purple: in order to assign an agent that is coded this color, the agent's shift will need to be extended into overtime to be assigned to this departure.

Red: agent is already assigned to either meet an arrival or dispatch a departure at the time this aircraft is planned to arrive. In order to assign an agent coded red, the coordinator would need to de-assign them from the other task first.

Orange: agent has previously been assigned to other tasks and thus has multiple pre-existing conflicts that should be resolved.

There are at least six columns underneath the Departure Selection Pool section. These are defined as follows:

✓

A coordinator would check this box if they wish to assign a particular agent to work this departure.

PRE-DPTR

Number of minutes prior to departure that the coordinator wishes the agent to be assigned to the departure. Can be anywhere from 5 to 120 minutes in 5 minute increments.

EMP#/STAT

Employee number of the agent's name found in the next column. “‘STAT” indicates whether the agent is scheduled full or part time today.

EMP NAME

Name of the employee.

SHIFT/AVAIL MIN

Shift of the agent expressed with Start Time and Off Time. “AVAIL MIN” is an indicator that tells the coordinator how many minutes (the left number) since the agent's last assignment and how many minutes (the right number) until the agent's next assignment.

D1

“D1” is an internal term used to indicate that the agent has been tasked as the primary agent for the departure. Checking this box will indicate to the agent that they are expected to assume the duties of the primary agent for this departure.

When the coordinator is satisfied with their assignments, they would click on the “Process” button, which will allow them to continue on to assign other flights. If they wish to abandon this process, they would click on the cancel button.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the true scope of the invention.

What is claimed is:

1. A computer based method for allocating and deploying personnel resources to transitory and fixed period work assignment tasks comprising the steps of:
(a) providing a first database containing work tasks related data;
(b) providing a second database containing personnel staffing data;
(c) providing first software which accesses the database of (a);
(d) providing second software which accesses the database of (b);
(e) generating at least one personnel staffing data record via the second software and storing the record within the database of (b);
(f) generating at least one work task related data record via the first software and storing said record within the database of (a);
(g) interrogating and combining data records stored within the database of (a) and (b) and storing the combined records into a fourth database via a fourth software;
(h) determining a user has communicated an input requirement via the fourth software of (g) which requires interrogation of information contained in the fourth database of (g);
(i) interrogating the fourth database of (g) in response to the user input requirement of (h); and
(j) formatting interrogated information of (i) responsive to the user input requirement of (h) and communicating said formatted information to the user.

2. The method of claim 1 where at least one of the databases of 1(a), 1(b) and 1(c) is interrogated in response to the user input requirement of 1(h).

3. The method of claim 2 further comprising formatting information interrogated in 1(i) and communicating the formatted information to the user.

4. The method of claim 1 wherein the user input requirement of 1(h) is communicated to the fourth software of 1(g) via a web site having user input navigation tools.

5. The method of claim 1 wherein the work task related data of 1(a) is commercial airline flight related data selected from a group of data including:
Scheduled Arrival Time, Scheduled Departure Time, Actual Arrival, Actual Departure Time, Taxi In Time, Taxi Out Time, Arrival Gate, Departure Gate, Tail Number, Actual Equipment Type, Passenger Counts, Capacity, Scheduled Destination Airport, Linked Previous Flight, Linked Next Flight, and Ground Objective.

6. The method of claim 1 wherein the personnel staffing related data of 1(b) is personnel staffing data generated via a global manning system.

7. The method of claim 6 wherein the personnel staffing related data is personnel staffing data selected from a group of data including: Employee Number, Employee First Name, Employee Last Name, Employee Status, Shift Start Time, Shift Off Time, Department, Position, Exception Type, Job, Job Start Time, Job End Time, Qualification, Linked Exception Employee Last Name, Linked Exception Employee First Name, Linked Exception Employee Number, Linked Exception Employee Position, Linked Exception Employee Department, Exception Start Time and Exception Off Time.

8. The method of claim 1 wherein the database of (i) is interrogated via proprietary passenger service software and allows the software to communicate with at least one user via a computer compatible communications network.

9. The method of claim 1 further comprising providing a third database and storing at least one transportation vehicle data record within the third database via a third software (PSS).

10. The method of claim 9 wherein the third software is software executed in cooperation with contemporary art commercial airline flight operation, passenger service and global manning systems.

11. The method of claim 9 wherein third software is proprietary flight operating system utilized by American Airlines and the contemporary art global manning system is StaffAdmin.

12. The method of claim 1 wherein determining a user has communicated an input requirement in 1(h) further comprises:
(a) accessing a web site mutually accessible to the user of 1(h);
(b) determining the user has specified an input requirement requesting information relating to transitory or fixed period work task assignment;
(c) interrogating the provided database of claim 1(g) and identifying information necessary to respond to the inquiry of 1(h);
(d) formatting the information identified in (c); and
(e) communicating the formatted information of (d) to the user of (b).

13. The method of claim 1 wherein determining a user has communicated an input requirement in 1(h) further comprises:
(a) accessing a proprietary database information record mutually accessible to the user 1(h) and first software of 1(c);
(b) determining the user has specified an input requirement for information relating to transitory or fixed period work task assignment;
(c) interrogating the database of claim (a) and identifying information necessary to respond to the inquiry of (b);
(d) formatting the information identified in (c); and
(e) communicating the formatted information to the user of 1(c).

14. The method of claim 1 further comprising interrogating and combining data records within first, second and third databases and storing the combined records within a fourth database via fourth software.

15. The method of claim 13 further comprising interrogating and combining data records within first, second and third databases and storing the combined records within a fourth database via fourth software.
